(19) United States
(12) Patent Application Publication
(10) Pub. No.: US 2020/0009884 A1
(43) Pub. Date: Jan. 9, 2020

(54) CURING APPARATUS AND INK JET RECORDING APPARATUS

(71) Applicant: Konica Minolta, Inc., Chiyoda-ku, Tokyo (JP)

(72) Inventor: Taiya MUNENAKA, Fuchu-shi, Tokyo (JP)

(21) Appl. No.: 16/490,508

(22) PCT Filed: Jan. 10, 2018
(86) PCT No.: PCT/JP2018/000229

§ 371 Date: Aug. 30, 2019

(30) Foreign Application Priority Data
Mar. 8, 2017 (JP) 2017-043373

(51) Int. Cl. B41J 11/00

(52) U.S. Cl. CPC B41J 11/0085; B41J 11/002

(57) ABSTRACT

A curing apparatus that applies predetermined energy and thereby cures a curable material includes a placement member, a sucker, a gas supplier, and an energy applier. The sucker sucks gas over a placement surface of the placement member through hole parts of the placement member, thereby attracting a placement target on the placement surface to the placement surface in a suction-attracting region. The gas supplier supplies a low-oxygen gas to the placement surface in a first region in the suction-attracting region. The energy applier applies, in a second region that is in the suction-attracting region and downstream from the first region in a moving direction of the placement member, the predetermined energy to the curable material on the placement target. The sucker sucks the gas such that a sucking force in the first region is smaller than a sucking force outside the first region.

### TECHNICAL FIELD

The present invention relates to a curing apparatus and an ink jet recording apparatus.

### BACKGROUND ART

There has been a curing apparatus that applies predetermined energy to and thereby cures curable materials that cure by application of the energy. Examples of the curable materials include ultraviolet curable resin and thermosetting resin. This curing apparatus can be used, for example, to fix, to sheet members, ink that is made of such a curable material and jetted to the sheet members from nozzles of an ink jet recording apparatus.

The curing apparatus may have a conveyance unit in which placement targets (e.g. the sheet members made of paper or resin, various kinds of substrates, etc.) are placed on a placement surface (e.g. outer circumferential surface) of a ring-shaped placement member, such as a conveying belt that circles along a predetermined circular path, and may apply energy to a curable material on the placement targets that are conveyed by the conveyance unit. For this kind of conveyance unit, there is a technology of attracting and fixing placement targets to the placement surface by sucking air from a side of the placement member opposite to a placement-surface side where the placement surface is provided, through a plurality of hole parts formed in the placement member.

When predetermined energy is applied to a curable material, polymerization of monomers in the curable material progresses and the monomers become macromolecules, so that the curable material cures. It is known that in curing of curable materials by polymerization, oxygen in reaction atmosphere inhibits polymerization of monomers and decreases curing efficiency. To cope with this, for the curing apparatus that is open to the air, there is a technology for preventing decrease in curing efficiency of curable materials by supplying a low-oxygen gas (e.g. an inert gas, such as nitrogen) having an oxygen concentration lower than an oxygen concentration of air to the placement surface of the placement member, thereby decreasing oxygen concentration in an area that is irradiated with energy (e.g. disclosed in Patent Literature 1).

### CITATION LIST

### Patent Literature

Patent Literature 1: JP 2007-185852 A

### SUMMARY OF INVENTION

### Technical Problem

However, the curing apparatus that, in conveying placement targets, attracts the placement targets to the placement surface of the placement member by sucking gas over the placement surface from the side of the placement member opposite to the placement-surface side through the hole parts formed in the placement member cannot decrease oxygen concentration over the placement surface enough, because the curing apparatus sucks the supplied low-oxygen gas to the side opposite to the placement-surface side. Consequently, the curing apparatus fails to sufficiently keep oxygen from inhibiting polymerization and efficiently cure curable materials.

Objects of the present invention include providing a curing apparatus and an ink jet recording apparatus that can more efficiently cure curable materials.

### Solution to Problem

In order to achieve the abovementioned object(s), the present invention described in claim 1 is a curing apparatus that applies predetermined energy to a curable material that cures by application of the predetermined energy, including:

a placement member that has a placement surface on which a placement target is placed;

a conveyance driver that moves the placement member along a predetermined movement path;

a sucker that performs, on a side of the placement member opposite to a placement-surface side where the placement surface is provided, a suction operation of sucking gas over the placement surface through a plurality of hole parts of the placement member, thereby attracting the placement target placed on the placement surface to the placement surface in a predetermined suction-attracting region of the movement path;

a gas supplier that supplies a low-oxygen gas having an oxygen concentration lower than an oxygen concentration of air to the placement surface in a predetermined first region being part of the suction-attracting region; and

an energy applier that applies the predetermined energy to the curable material on the placement target attracted to the placement surface, in a predetermined second region that is in the suction-attracting region and downstream from the first region in a moving direction of the placement surface in the suction-attracting region, the placement surface moving according to the movement of the placement member, wherein

the sucker performs the suction operation such that a sucking force in the first region is smaller than a sucking force outside the first region.

The present invention described in claim 2 is the curing apparatus according to claim 1, including a plurality of air chambers that are provided on the side of the placement member opposite to the placement-surface side in an area corresponding to the suction-attracting region, and from each of which gas is sent to the placement-surface side of the placement member and vice versa through a channel passing through at least one of the hole parts of the placement member, wherein

the air chambers include a first air chamber provided in an area corresponding to the first region and one or more second air chambers provided in an area corresponding to the outside of the first region, and

in the suction operation, the sucker sucks the gas from the side of the placement member opposite to the placement-surface side through the air chambers such that the sucking force in the first air chamber is smaller than the sucking force in the one or more second air chambers.

The present invention described in claim 3 is the curing apparatus according to claim 2, wherein in the suction operation, the sucker sucks the gas through, among the air chambers, the one or more second air chambers only.

The present invention described in claim 4 is the curing apparatus according to claim 1, including an air chamber that is provided on the side of the placement member opposite to the placement-surface side in an area corresponding to the outside of the first region in the suction-attracting region, and from which gas is sent to the placement-surface side of the placement member and vice versa through a channel passing through at least one of the hole parts of the placement member, wherein

in the suction operation, the sucker sucks the gas from the side of the placement member opposite to the placement-surface side through the air chamber.

The present invention described in claim 5 is the curing apparatus according to any one of claims 1 to 4, including a gas circulator that flows the gas over the placement surface by supplying, in the first region, a predetermined gas to the placement surface in an area upstream in the moving direction from an area to which the gas supplier supplies the low-oxygen gas.

The present invention described in claim 6 is the curing apparatus according to claim 5, wherein the gas circulator sends the predetermined gas to the placement surface in a direction having a component counter to the moving direction.

The present invention described in claim 7 is the curing apparatus according to any one of claims 1 to 4, including a gas circulator that flows the gas over the placement surface by sucking, in the first region, the gas over the placement surface in an area upstream in the moving direction from an area to which the gas supplier supplies the low-oxygen gas.

The present invention described in claim 8 is the curing apparatus according to any one of claims 1 to 7, wherein the gas supplier sends the low-oxygen gas to the placement surface in a direction having a component following the moving direction.

The present invention described in claim 9 is the curing apparatus according to any one of claims 1 to 8, including a flow area limiting member that limits, in the first region and the second region, a flow area of the gas over the placement surface in a direction perpendicular to the placement surface.

The present invention described in claim 10 is the curing apparatus according to any one of claims 1 to 9, including a suction controlling unit that causes the sucker to perform the suction operation such that the sucking force in the first region is smaller in response to the curable material being applied to a predetermined area of the placement target including a top of the placement target in the moving direction than in response to the curable material not being applied to the predetermined area of the placement target.

The present invention described in claim 11 is the curing apparatus according to any one of claims 1 to 10, wherein

the conveyance driver causes the placement member to circle along a predetermined circular path, and the curing apparatus includes a placement target feeder that places placement targets each of which is the placement target on the placement surface of the placement member, which circles along the predetermined circular path, at intervals of a distance that is shorter than a length of the first region in the moving direction.

Furthermore, in order to achieve the abovementioned object(s), the present invention described in claim 12 is an ink jet recording apparatus including:

a jetter that jets, from a nozzle to a placement target, ink made up of a curable material that cures by application of predetermined energy; and

the curing apparatus according to any one of claims 1 to 11.

### Advantageous Effects of Invention

According to the present invention, curable materials can be more efficiently cured.

### BRIEF DESCRIPTION OF DRAWINGS

FIG. 1 is a schematic view showing an overall configuration of an ink jet recording apparatus.

FIG. 2 is a block diagram showing main functional components of the ink jet recording apparatus.

FIG. 3 is a schematic cross-sectional view showing part of a fixing unit in an enlarged manner.

FIG. 4A is an illustration to explain control of a suction operation that is performed by a support-suction unit according to a first modification.

FIG. 4B is an illustration to explain the control of the suction operation that is performed by the support-suction unit according to the first modification.

FIG. 5 is a schematic cross-sectional view showing part of the fixing unit according to a second modification in an enlarged manner.

FIG. 6A is a schematic cross-sectional view showing part of the fixing unit according to a third modification in an enlarged manner.

FIG. 6B is a schematic cross-sectional view showing part of the fixing unit according to the third modification in an enlarged manner.

### DESCRIPTION OF EMBODIMENTS

Hereinafter, an embodiment(s) of a curing apparatus and an ink jet recording apparatus according to the present invention will be described with reference to the drawings.

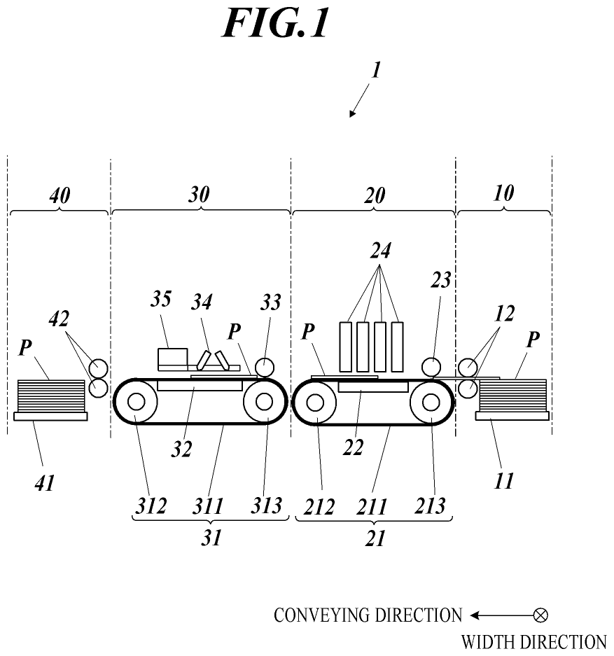

FIG. 1 is a schematic view showing an overall configuration of an ink jet recording apparatus as an embodiment of the present invention.

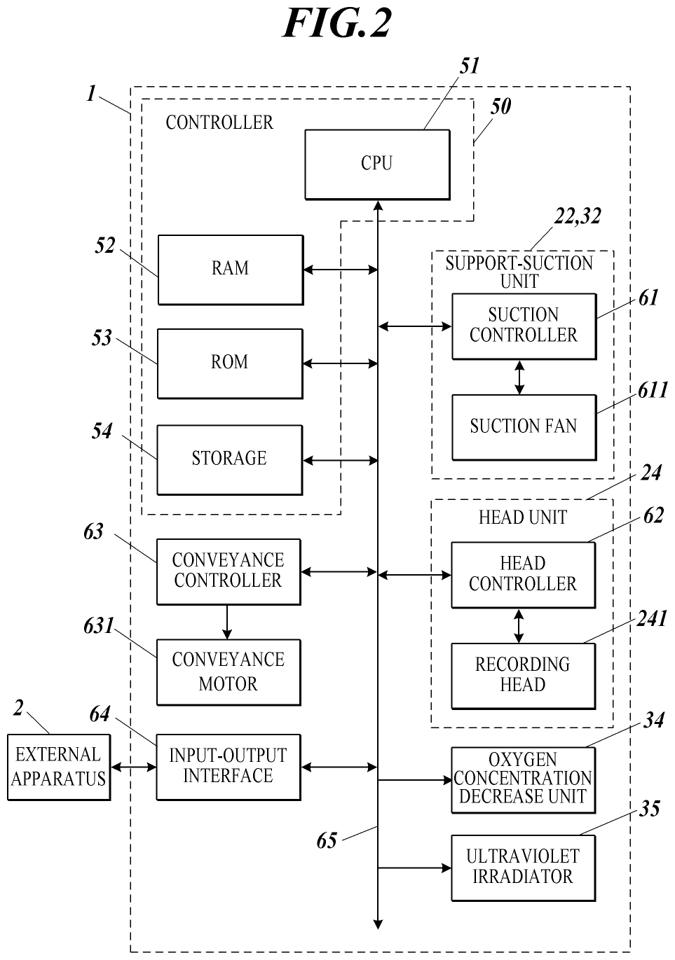

An inkjet recording apparatus 1 includes a recording medium feeder 10 (placement target feeder), an image recorder 20 (jetter), a fixing unit 30, and a recording medium receiver 40. Among these, the fixing unit 30, a controller 50, and a suction controller 61 (FIG. 2) constitute a curing apparatus. Components that constitute the inkjet recording apparatus 1 are not limited to the abovementioned ones. For example, between the recording medium feeder 10 and the image recorder 20, there may be provided a heater that heats recording media and/or a medium treating unit that performs surface modification treatment, such as corona treatment, on recording media.

The recording medium feeder 10 includes a placement tray 11 and medium sending rollers 12.

The placement tray 11 is a plate-shaped member that can store thereon various types of separate recording media P (placement targets) in piles. Examples of the recording media P include sheet paper, thick paper, corrugated cardboard, and resin plates. The recording media P are sent to the image recorder 20 in order from the recording medium P placed uppermost on the placement tray 11. The placement tray 11 is movable up and down, and is positioned according to, for example, the total weight of the stored recording media P so that the recording medium P placed uppermost can be sent to the image recorder 20. For the recording media P, various materials that allow ink jetted thereto to solidify can be used. Examples of the materials include fabric, resin, and paper exemplified by plain paper and coated paper.

The medium sending rollers 12 are freely rotatable rollers that pinch each recording medium P from above and underneath. The medium sending rollers 12 send the recording medium P placed uppermost on the placement tray 11 in a horizontal direction herein. The medium sending rollers 12 are equipped with guiding members that adjust each recording medium P to a predetermined position in a width direction perpendicular to a conveying direction in which recording media P are conveyed (leftward in FIG. 1). The medium sending rollers 12 send the recording medium P, the position of which has been adjusted in the width direction, to the image recorder 20.

The image recorder 20 records an image(s) by jetting ink to the recording medium P delivered from the recording medium feeder 10, and sends the recording medium P on which the image has been recorded to the fixing unit 30. The image recorder 20 includes: a conveyance unit 21 that includes a conveying belt 211, a driving roller 212, and a driven roller 213; a support-suction unit 22; a pressing roller 23; and one or more (four, herein) head units 24 that jet ink.

The conveying belt 211 of the conveyance unit 21 is an endless (ring-shaped) belt-shaped member stretched around the driving roller 212 and the driven roller 213. Herein, a steel belt is used. As the steel belt, for example, stainless steel, such as SUS304 or SUS631, or aluminum alloy having a thickness of approximately 0.3 mm can be used. The conveying belt 211 is air-permeable and has a plurality of hole parts having the same opening shape and passing through the outer and inner circumferential surfaces of the conveying belt 211, or more specifically, a large number of (a plurality of) round-shaped hole parts having a diameter of approximately 0.5 mm arranged at intervals of approximately 1.4 mm such that an open area ratio becomes approximately 20%.

The conveying belt 211 is stretched around the driving roller 212 and the driven roller 213 (which hereinafter may be collectively called conveying rollers 212, 213), so that its outer circumferential surface on which recording media P are placed (surface not contacting the conveying rollers 212, 213) is movable along a circular path (movement path) around the conveying rollers 212, 213. That is, the conveying belt 211 (and the outer circumferential surface) circles along the circular path around the conveying rollers 212, 213 at a rotation speed and in a rotation direction of the driving roller 212 that is driven to rotate by a conveyance motor 631 (conveyance driver) (FIG. 2). Herein, counterclockwise rotation of the driving roller 212 in a plane shown in FIG. 1 moves the conveying belt 211 in the normal conveying direction of recording media P (moving direction of the conveying belt 211 in a suction-attracting region where the support-suction unit 22 performs suction). On the outer circumferential surface (placement surface) of the conveying belt 211, the recording medium P sent from the recording medium feeder 10 is placed, and conveyed as the conveying belt 311 moves.

The support-suction unit 22 supports the inner circumferential surface (surface contacting the conveying rollers 212, 213) of the conveying belt 211 with its flat surface (horizontal surface, herein) (hereinafter called supporting surface) in an area in a section of the conveying belt 211 between the two conveying rollers 212, 213. The area includes a part where the recording medium P that is conveyed, namely the placement surface of the conveying belt 211, faces ink jetting surfaces of the head units 24. The support-suction unit 22 attracts the recording medium P placed on the placement surface of the conveying belt 211 to the placement surface with a suction fan(s) 611 (FIG. 2) sucking air from the inner-circumferential-surface side of the conveying belt 211 through the hole parts of the conveying belt 211.

The head units 24 are arranged so as to face the support-suction unit 22 with the conveying belt 211 in between. One side of each head unit 24 facing the support-suction unit 22 is the ink jetting surface provided with opening parts of nozzles. Each head unit 24 jets ink to and makes the ink land on the recording medium P that is conveyed while being attracted to the placement surface of the conveying belt 211 by the suction-support unit 22. Each head unit 24 has one or more recording heads 241 (FIG. 2) having the opening parts of the nozzles arranged at predetermined positions, and jetting ink from the opening parts of the nozzles. The arrangement area of the nozzles in each head unit 24 in the width direction covers an image recording area of each recording medium P in the width direction. When recording an image(s), each head unit 24 is used with its position fixed, and consecutively jets ink to different points on a recording medium P in the conveying direction at predetermined intervals (conveying-direction intervals) according to the conveyance of the recording medium P, thereby recording the image(s) with a single-pass system. Herein, the four head units 24 are connected to their respective ink tanks (not illustrated) of cyan (C), magenta (M), yellow (Y), and black (K), and jet ink of the respective colors of C, M, Y, K. The image recorder 20 may have a head unit(s) 24 that jets ink of a color(s) other than the four colors: for example, ink of orange, green, violet, red, blue or white, or transparent ink.

As the ink that is jetted from the nozzles of the head units 24, ink that changes its phases between gel and sol is used. Herein, gel is classified as a solid, and sol is classified as a liquid. In this embodiment, ink that has gelled by heat is jetted from the nozzles of the head units 24. The ink that has landed on recording media P gels swiftly by being cooled, and solidifies on the recording media P.

In this embodiment, the ink to be used has a property of curing (curable material) by ultraviolet irradiation. As such a kind of ink, ink that contains photopolymerizable compounds (monomers), a photoinitiator, a gelling agent, and a coloring agent is used. The photopolymerizable compounds are compounds that become macromolecules by polymerization that progresses by ultraviolet irradiation. Being macromolecules cures the ink. The photoinitiator is a compound for initiating the abovementioned polymerization. The gelling agent is a compound having properties of: dissolving in color ink when the color ink is heated to a temperature equal to or higher than a solating temperature, thereby making the ink sol; and forming a bridged structure or fibrous associations when the ink is cooled to a temperature equal to or lower than a gelling temperature, thereby making the ink gel. The coloring agent contains a dye or a pigment of the color ink.

The fixing unit 30 is provided downstream from the image recorder 20 in the conveying direction of recording media P. The fixing unit 30 cures and fixes the ink on the recording medium P delivered from the image recorder 20, by irradiating the (gel) ink on the recording medium P with ultraviolet rays. The fixing unit 30 includes: a conveyance unit 31 that includes a conveying belt 311 (placement member), a driving roller 312 that is driven to rotate by a conveyance motor 631 (conveyance driver) (FIG. 2), and a driven roller 313; a support-suction unit 32 (sucker); a pressing roller 33; an oxygen concentration decrease unit 34; and an ultraviolet irradiator 35 (energy applier). The conveyance unit 31, the support-suction unit 32, and the pressing roller 33 can be configured in the same manner as the conveyance unit 21, the support-suction unit 22, and the pressing roller 23 of the image recorder 20, respectively.

The oxygen concentration decrease unit 34 decreases oxygen concentration over the placement surface of the conveying belt 311 by supplying, to the placement surface, a low-oxygen gas (in this embodiment, nitrogen) having an oxygen concentration lower than an oxygen concentration of air (approximately 21%).

The ultraviolet irradiator 35 irradiates, with ultraviolet rays, the recording medium P that is conveyed while being attracted to the placement surface of the conveying belt 311 by the suction-support 32, thereby curing and fixing the ink on the recording medium P.

The recording medium receiver 40 stores and keeps the recording medium P delivered from the fixing unit 30 until a user takes out the recording medium P. The recording medium receiver 40 includes a receiving tray 41 and guiding rollers 42. The recording medium receiver 40 conveys each recording medium P by pinching the recording medium P from above and underneath with the guiding rollers 42, and places the recording medium P on the receiving tray 41. The receiving tray 41 is set to be lower than the placement surface of the conveyance unit 31 so that the recording medium/media P can be sent from the placement surface, and may be movable up and down according to the amount of the stored recording media P.

Thus, the ink jet recording apparatus 1 is configured such that while the conveyance units 21, 31 are conveying recording media P, the image recorder 20 and the fixing unit 30, which include the conveyance units 21, 31, respectively, perform predetermined operations on the recording media P. This configuration can shorten the sections for which recording media P are kept placed on the conveying belts 211, 311 of the conveyance units 21, 31, and consequently can prevent decrease in accuracy of positions of recording media P in the conveying direction due to, for example, swelling, expansion/contraction, or non-uniform moving speed(s) of the conveying belts 211, 311. This configuration allows, in particular, the image recorder 20 to jet ink to desired points on recording media P. If, for example, accuracy of the positions in the conveying direction is not important, the ink jet recording apparatus 1 may be configured such that while a single conveyance unit is conveying recording media P, the image recorder 20 jets and the fixing unit 30 fixes ink to the recording media P.

FIG. 2 is a block diagram showing main functional components of the ink jet recording apparatus 1.

The ink jet recording apparatus 1 includes: the controller 50; the support-suction units 22, 32 including the suction controller(s) 61 and the suction fans 611; the head units 24 including the recording heads 241 and a head controller(s) 62; the oxygen concentration decrease unit 34; the ultraviolet irradiator 35; a conveyance controller(s) 63; the conveyance motors 631; an input-output interface 64; and a bus 65. Among these, as the suction controller 61, the head controller 62, and the conveyance controller 63, hardware components of the controller 50 may be used, or exclusive-use CPUs, memories, logic circuits, and so forth may be prepared. The controller 50 and the suction controller 61 constitute a suction controlling unit.

The controller 50 includes a CPU 51 (Central Processing Unit), a RAM 52 (Random Access Memory), a ROM 53 (Read Only Memory), and a storage 54.

The CPU 51 reads out programs for various kinds of control and setting data that are stored in the ROM 53, causes the RAM 52 to store the read ones, and performs various kinds of arithmetic processing by executing the programs. The CPU 51 integrally controls the overall operation of the ink jet recording apparatus 1.

The RAM 52 provides the CPU 51 with a memory space for work, and stores temporary data. The RAM 52 may include a nonvolatile memory.

The ROM 53 stores the programs for various kinds of control, which are executed by the CPU 51, the setting data, and so forth. Instead of the ROM 53, a rewritable nonvolatile memory, such as an EEPROM (Electrically Erasable Programmable Read Only Memory) or a flash memory, may be used.

The storage 54 stores print jobs (image recording commands) and image data of images to be recorded relevant to the print jobs input from an external apparatus 2 through the input-output interface 64, and so forth. As the storage 54, for example, an HDD (Hard Disk Drive) is used, or a DRAM (Dynamic Random Access Memory) may be jointly used.

The suction controller 61 rotates the suction fans 611 of the support-suction units 22, 32 at rotation speeds based on control signals from the controller 50.

The head controller 62 outputs various control signals and image data to head drive units in the recording heads 241 at appropriate timings in accordance with control signals from the controller 50, thereby causing the recording heads 241 to jet ink from the opening parts of the nozzles.

The conveyance controller 63 individually controls, on the basis of control signals supplied from the controller 50, operations of the conveyance motors 631 attached to the medium sending rollers 12 and the driving rollers 212, 312 to rotate the rollers, thereby supplying recording media P to the image recorder 20 at predetermined timings and conveying the recording media P at an appropriate speed(s).

The input-output interface 64 mediates data exchange between the external apparatus 2 and the controller 50. The input-output interface 64 is made up of, for example, one of or a combination of any of a variety of serial interfaces and/or any of a variety of parallel interfaces.

The bus 65 is a channel for the controller 50 and the other components to exchange signals.

The external apparatus 2 is, for example, a personal computer, and supplies the print jobs, the image data, and so forth to the controller 50 through the input-output interface 64.

Next, the configuration and operation of the fixing unit 30 will be described in detail.

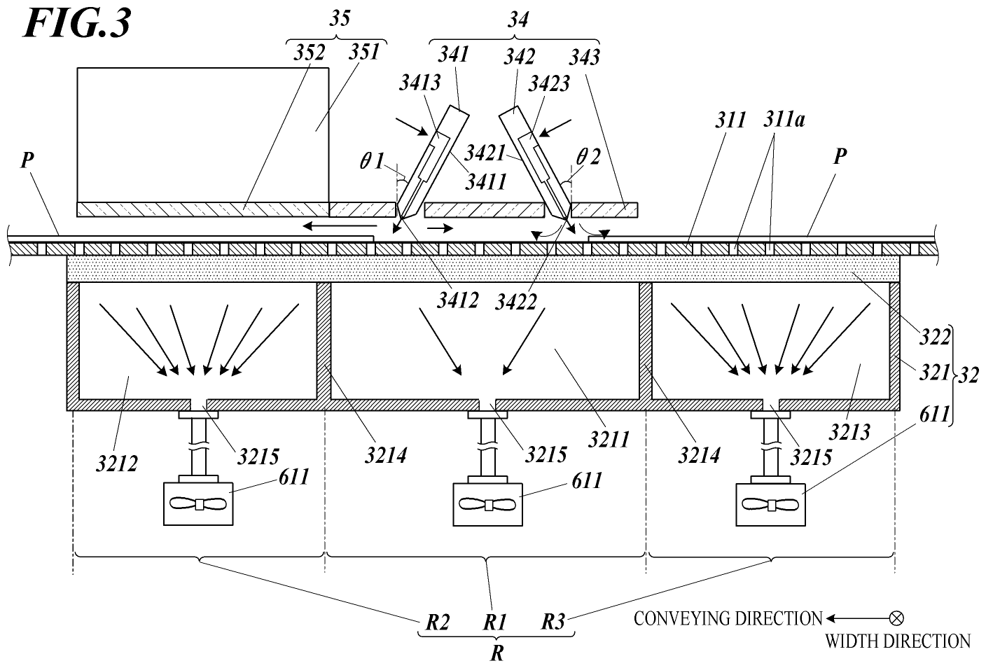

FIG. 3 is a schematic cross-sectional view showing part of the fixing unit 30 in an enlarged manner. FIG. 3 shows a section of the fixing unit 30 perpendicular to the width direction, wherein the support-suction unit 32, the oxygen concentration decrease unit 34, and the ultraviolet irradiator 35 are shown.

The support-suction unit 32 includes: a cuboid casing 321 one side of which is open, the side facing the conveying belt 311; partition walls 3214 that partition the interior of the casing 321 into air chambers (chambers) 3211, 3212, 3213; a porous member 322 that is placed on the partition walls 3214 so as to overlie and cover the open side of the casing 321; and the suction fans 611 that suck air in the air chambers 3211, 3212, 3213. Between the casing 321 and the porous member 322, a supporting plate having a plurality of vent holes may be arranged to support the porous member 322.

The casing 321 and the partition walls 3214 are made up of metallic plates of stainless steel, aluminum alloy or the like having a thickness ranging from approximately 1 mm to several mm. The partition walls 3214 are welded and fixed to the bottom and lateral surfaces of the casing 321 so as to be perpendicular to the bottom of the casing 321. Consequently, spaces between the partition walls 3214 and the casing 321 are sealed up, and no air permeability is present there. The interior of the casing 321 is partitioned by the two partition walls 3214, which are perpendicular to the conveying direction, into the three air chambers 3211, 3212, 3213 that are adjacent to one another along the conveying direction. The air chambers are arranged in the order of the air chambers 3213, 3211, and 3212 from the upstream side in the conveying direction. Hereinafter, of the circular path of the conveying belt 311, a region corresponding to the upper part of the air chamber 3211 located at the middle in the conveying direction (first air chamber) is called first region R1; a region corresponding to the upper part of the air chamber 3212 located downmost in the conveying direction (second air chamber) is called second region R2; and a region corresponding to the upper part of the air chamber 3213 located uppermost in the conveying direction (second air chamber) is called a third region R3. In this embodiment, the length of the first region R1 in the conveying direction is approximately 200 to 300 mm. The length of each of the second region R2 and the third region R3 in the conveying direction is not limited to a particular value, but determined according to, for example, the size of recording media P to be conveyed, and may be approximately a few hundred mm to 1,000 mm.

The porous member 322 is a flat-plate-shaped member having a thickness of approximately 5 mm. The upper surface of the porous member 322 is parallel to a horizontal plane, and constitutes a supporting surface of the support-suction unit 32. The upper surface of the porous member 322 (support-suction unit 32) is positioned slightly higher than a line connecting the upper end of the driving roller 312 to the upper end of the driven roller 313. The conveying belt 311 that is supported by the porous member 322 slides on the porous member 322 with a recording medium/media P placed on the conveying belt 311 without changing the position of the recording medium P in the vertical direction.

As the porous member 322, a plate-shaped member that is made of sintered particles of resin, such as polypropylene resin, polyethylene resin, or fluororesin, may be used. The porous member 322 has reticulated gas channels inside connecting to one another three-dimensionally, thereby being gas-permeable three-dimensionally.

The porous member 322 made of the abovementioned material has a small frictional resistance with the conveying belt 311. This can prevent damage to the conveying belt 311, and can reduce a load on the conveyance motor 631. This small frictional resistance can also make the amount of abrasion powder extremely small, the abrasion powder being generated when the conveying belt 311 slides on the porous member 322.

In the bottom of the casing 321, suction ports 3215 are formed for the respective three air chambers 3211, 3212, 3213. The suction fans 611 are attached to ducts that are connected to the suction ports 3215. The suction fans 611 discharge the air in the corresponding air chamber 3211, 3212, 3213, to which the suction fans 611 are connected through the ducts, thereby generating negative pressure in the air chambers. With the negative pressure, the support-suction unit 32 performs, in a suction-attracting region R including the first region R1, the second region R2, and the third region R3, a suction operation of sucking air from a side of the conveying belt 311 opposite to a placement-surface side where the placement surface is provided, through hole parts 311a of the conveying belt 311, thereby attracting a recording medium/media P to the placement surface of the conveying belt 311.

The rotation operations of the three suction fans 611 are controlled individually by the suction controller 61. More specifically, the rotation speeds of the suction fans 611 are controlled such that an absolute value of the negative pressure in the air chamber 3211, which is located at the middle in the conveying direction, is smaller than an absolute value of the negative pressure in each of the other air chambers 3212, 3213. Consequently, sucking force for attracting a recording medium/media P in the first region R1 is smaller than sucking force in each of the second region R2 and the third region R3. Although a magnitude relation between the sucking force in the second region R2 and the sucking force in the third region R3 is not limited to a particular balance, they are the same in this embodiment.

A magnitude of the sucking force in the suction-attracting region R may be adjusted to be larger for thicker recording media P.

In a case of making difference in the sucking force of the suction fans 611 in/for the air chambers, the horizontal flow of gas in the porous member 322 could diminish difference in the negative pressure. However, because the air chambers are separated from one another by the partition walls 3214 under the porous member 322, the difference in the sucking force in the air chambers can be sufficient. In order to effectively generate the difference in the sucking force, it is desired that the height of the air chambers 3211, 3212, 3213 be greater than the thickness of the porous member 322, at least. It is further preferable that the height of the air chambers 3211, 3212, 3213 be three times as great as the thickness of the porous member 322 or greater.

The ultraviolet irradiator 35 includes: a main body 351 that irradiates recording media P, which are conveyed by the conveying belt 311, with ultraviolet rays; and a partition plate 352 (flow area limiting member) provided at one side of the main body 351, the side facing the conveying belt 311. The main body 351 and the partition plate 352 are provided in an area corresponding, in the conveying direction, to the second region R2 of the support-suction unit 32. The partition plate 352 is a translucent plate-shaped member, herein, a glass plate, arranged parallel to the placement surface of the conveying belt 311 with a predetermined distance (approximately a few mm to several ten mm) away from the placement surface. The partition plate 352 limits, in the second region R2, a flow area of gas over the placement surface in a direction perpendicular to the placement surface. The main body 351 irradiates each recording medium P facing the partition plate 352 with ultraviolet rays through the partition plate 352 in an area that, in the width direction, covers the width of the recording medium P, and in the conveying direction, is predetermined to sufficiently cure the ink on the recording medium P, which is being conveyed.

The oxygen concentration decrease unit 34 is provided upstream from the ultraviolet irradiator 35 in the conveying direction, and includes a first air knife 341 (gas supplier), a second air knife 342 (gas circulator), and a partition plate 343 (flow area limiting member). FIG. 3 shows sections of the first air knife 341, the second air knife 342, and the partition plate 343, the sections being perpendicular to the width direction.

The partition plate 343 is a glass plate arranged parallel to the placement surface of the conveying belt 311 with the same distance away from the placement surface as the abovementioned distance between the partition plate 352 and the placement surface. The partition plate 343 is provided in an area corresponding to the first region R1 of the support-suction unit 32, and arranged so as to contact the partition plate 352. The partition plate 343 limits, in the first region R1, a flow area of gas over the placement surface in a direction perpendicular to the placement surface. The partition plate 343 is provided with two opening parts that extend, in the width direction, longer than the width of recording media P. The member constituting the partition plate 343 is not limited to a glass plate, and as the member, one that is made of any other material with no gas permeability can be used.

The first air knife 341 supplies nitrogen as a low-oxygen gas having an oxygen concentration lower than the oxygen concentration of air from one of the two opening parts of the partition plate 343, the one being downstream in the conveying direction, to the placement surface of the conveying belt 311 in the first region R1. The first air knife 341 has a flat-plate-shaped main body 3411 that is, in the width direction, longer than the width of recording media P. The main body 3411 is arranged such that the tip part of the main body 3411 passes through the opening part of the partition plate 343, so that the tip thereof faces the placement surface. At the tip of the main body 3411, a gas ejecting part 3412 having an approximately one-millimeter wide slit is provided. Inside the main body 3411, a gas introducing channel 3413 that communicates with the gas ejecting part 3412 is provided. The first air knife 3411 ejects (sends) nitrogen introduced from outside into the gas introducing channel 3413 by application of a predetermined pressure, at a speed for the abovementioned pressure, from the gas ejecting part 3412 to a linear area that extends in the width direction on the placement surface.

The first air knife 341 is arranged such that the extending direction of the main body 3411 slants upstream in the conveying direction from the vertical direction by an angle θ1, and ejects nitrogen in a direction along the extending direction of the main body 3411. That is, the first air knife 341 ejects nitrogen to the placement surface in a direction having a component following the conveying direction. The angle θ1 is not limited to a particular degree, but can be, for example, within a range of approximately 15 to 45 degrees.

Nitrogen supplied by the first air knife 341 replaces the existing air in a space between the placement surface of the conveying belt 311 (or a recording medium P on the conveying belt 311) and the partition plate 343 (hereinafter called first partition space), thereby filling the first partition space. Nitrogen filling the first partition space flows in the conveying direction as the conveying belt 311 and a recording medium P on the conveying belt 311 move in the conveying direction, and consequently moves to a space between the partition plate 352 of the ultraviolet irradiator 35 and the placement surface of the conveying belt 311 (or a recording medium P on the conveying belt 311) (hereinafter called second partition space). As a result of this, nitrogen concentration in the second partition space increases, and oxygen concentration in the second partition space decreases accordingly.

In curing of ink by polymerization of photopolymerizable compounds described above, oxygen in reaction atmosphere inhibits polymerization of monomers and decreases curing efficiency. To cope with this, in this embodiment, nitrogen supplied from the first air knife 341 is led to the second partition space as described above. This decreases the oxygen concentration in the second partition space and prevents decrease in curing efficiency of ink.

In the first region R1, where the first air knife 341 supplies nitrogen, if a recording medium P is on the conveying belt 311, the sucking force of the support-suction unit 32 is used for attracting the recording medium P, and the gas in the first partition space is hardly sucked by the support-suction unit 32 accordingly. On the other hand, as shown in FIG. 3, in at least part of the first region R1, if no recording medium P is on the conveying belt 311, namely a space between recording media P is in the first region R1 owing to the conveyance of the recording media P, nitrogen supplied by the first air knife 341 is likely to be sucked by the sucking force of the support-suction unit 32. To cope with this, in this embodiment, the sucking force in the first region R1 is smaller than the sucking force in each of the second region R2 and the third region R3 as described above. This minimizes the suction amount of the supplied nitrogen sucked by the support-suction unit 32.

In this embodiment, positions of recording media P are adjusted such that an interval between the recording media P in the conveying direction is shorter than the length of the first region R1 in the conveying direction. Hence, at any timing of the circular movement of the conveying belt 311, a recording medium/media P is placed on the placement surface of the conveying belt 311 in at least one of the second region R2 and the third region R3 that are adjacent to the first region R1 along the conveying direction. This hinders the support-suction unit 32 from sucking nitrogen supplied from the first air knife 341.

The second air knife 342 supplies nitrogen from one of the two opening parts of the partition plate 343, the one being upstream in the conveying direction, to the placement surface of the conveying belt 311 in the first region R1. The second air knife 342 has a main body 3421 provided with a gas ejecting part 3422 and a gas introducing channel 3423. The main body 3421, the gas ejecting part 3422, and the gas introducing channel 3423 are configured in the same manner as the main body 3411, the gas ejecting part 3412, and the gas introducing channel 3413 of the first air knife 341, respectively.

The second air knife 342 is arranged such that the extending direction of the main body 3421 slants downstream in the conveying direction from the vertical direction by an angle θ2, and ejects nitrogen in a direction along the extending direction of the main body 3421. That is, the second air knife 342 ejects nitrogen to the placement surface in a direction having a component counter to the conveying direction. In this embodiment, an absolute value of the angle θ2 is the same as an absolute value of the angle θ1, but may be different from that of the angle θ1.

The second air knife 342 ejects nitrogen to the placement surface of the conveying belt 311, thereby flowing and stirring the layer of the gas over the placement surface. This can smoothly spread nitrogen supplied by the first air knife 341 in the first partition space, and efficiently decrease the oxygen concentration in the second partition space. In this embodiment, because the sucking force in the first region R1 is smaller than the sucking force in each of the second region R2 and the third region R3, the suction amount of nitrogen sucked by the support-suction unit 32 can be made small, the nitrogen being supplied from the second air knife 342. This can efficiently flow and stir the layer of the gas over the placement surface, even if a space between recording media P is in the first region R1 owing to the conveyance of the recording media P.

The air knife 342 can effectively flow and stir the layer of the gas in the first partition space by ejecting nitrogen to the placement surface in the direction having the component counter to the conveying direction, the direction having the component corresponding to the slant of the main body 3421.

The gas that is supplied from the second air knife 342 may be different from the gas that is supplied from the first air knife 341. In order to efficiently decrease the oxygen concentration in the first and second partition spaces, however, it is preferable that the gas that is supplied from the second air knife 342 be also a low-oxygen gas.

The first and second air knives start supplying nitrogen before the ink jet recording apparatus 1 starts recording images, and keep supplying nitrogen until the ink jet recording apparatus 1 finishes (ends) recording images. The first and second air knives may stop supplying nitrogen at the timing when the inkjet recording apparatus 1 stops supplying recording media P or stops the head units 24 from jetting ink, for example.

The above configuration and operation of the oxygen concentration decrease unit 34 can decrease the oxygen concentration in the second partition space to approximately 5%. The oxygen concentration in the second partition space being lower than the oxygen concentration of air, namely, even a value higher than 5%, about 10% for example, is effective in preventing decrease in curing efficiency of ink. However, the oxygen concentration being too low makes the curing efficiency of ink too high, which causes a problem of unnaturally high gloss of recorded images. It is, therefore, preferable that the oxygen concentration in the second partition space be higher than or equal to a lower limit that does not cause such a problem.

In this embodiment, the ends of the first and second partition spaces in the width direction are open. Although this configuration can sufficiently decrease the second partition space, if, for example, it is necessary to further decrease the oxygen concentration in the second partition space, the ends of the first and second partition spaces in the width direction may be sealed.

### [First Modification]

Next, a first modification of the above embodiment will be described. This modification differs from the above embodiment in that the suction operation performed by the support-suction unit 32 is controlled in accordance with the position of ink on each recording medium P. Hereinafter, points in which the first modification differs from the above embodiment are described.

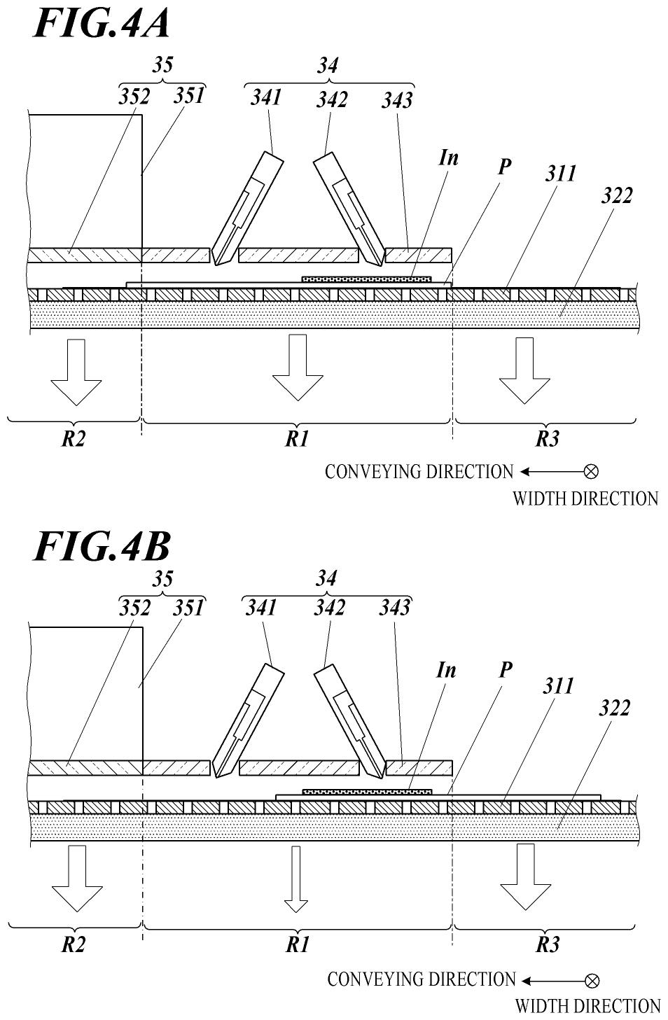

FIG. 4A and FIG. 4B are illustrations to explain control of the suction operation that is performed by the support-suction unit 32 in this modification.

FIG. 4A is an illustration to explain the suction operation performed by the support-suction unit 32 in a case where ink In is not applied to a predetermined area of a recording medium P, herein, from the top (downstream end in the conveying direction) to the center of the recording medium P in the conveying direction (hereinafter called downstream part of a recording medium P). FIG. 4B is an illustration to explain the suction operation performed by the support-suction unit 32 in a case where the ink In is applied to the downstream part of a recording medium P. For convenience of explanation, in FIG. 4A and FIG. 4B, the length of the recording medium P in the conveying direction is shortened.

As shown in FIG. 4A, in the case where the ink In is not applied to the downstream part of a recording medium P, the downstream part of the recording medium P faces the first air knife 341 before the ink In faces the first air knife 341. In this situation, the sucking force of the support-suction unit 32 is mainly used for attracting the downstream part of the recording medium P, and regardless of magnitude of the sucking force of the support-suction unit 32 in the first region R1, nitrogen supplied from the first air knife 341 to the downstream part of the recording medium P is hardly sucked by the support-suction unit 32, and efficiently fills the first partition space, namely over the recording medium P in the first partition space. The nitrogen filling over the recording medium P moves to the second partition space together with the recording medium P as the recording medium P is conveyed, and consequently can decrease the oxygen concentration in the second partition space when the ultraviolet irradiator 35 cures and fixes the ink In on the recording medium P.

Thus, in this modification, in the case where the ink In is not applied to the downstream part of a recording medium P, the oxygen concentration in the second partition space can efficiently decrease regardless of magnitude of the sucking force of the support-suction unit 32 in the first region R1. Hence, the sucking force of the support-suction unit 32 in the first region R1 is set to be the same as the sucking force of the support-suction unit 32 in each of the second region R2 and the third region R3.

Meanwhile, in the case where the ink In is applied to the downstream part of a recording medium P as shown in FIG. 4B, the recording medium P does not face the first air knife 341 until right before the ink In faces the first air knife 341. That is, a situation in which nitrogen supplied from the first air knife 341 is easily sucked by the support-suction unit 32 in the first region R1 continues until right before the ink In faces the first air knife 341. Because of this, the nitrogen is unlikely to fill over the downstream part of the recording medium P, and consequently hardly decreases the oxygen concentration in the second partition space with the recording medium P moved to the second partition space.

To cope with this, in this modification, in the case where the ink In is not applied to the downstream part of a recording medium P, the rotation speeds of the suction fans 611 are controlled such that the sucking force of the support-suction unit 32 in the first region R1 is smaller than the sucking force of the support-suction unit 32 in each of the second region R2 and the third region R3. This can reduce the suction amount of nitrogen sucked by the support-suction unit 32, the nitrogen being supplied from the first air knife 341 until right before the ink In faces the first air knife 341, and efficiently fill the first partition space with the nitrogen.

In this modification, image data related to a print job are analyzed before image recording starts in order to determine whether or not to jet ink to the downstream part of each recording medium P. If it is determined to jet ink to the downstream part of each recording medium P, the suction fans 611 of the support-suction unit 32 start rotating at speeds that make the sucking force in the first region R1 smaller than the sucking force in each of the second region R2 and the third region R3, and in this state, images are recorded on recording media P on the basis of the image data.

In the case where the ink In is not applied to the downstream part of a recording medium P as shown in FIG. 4A, the sucking force in the first region R1 may be set to be smaller than the sucking force in each of the second region R2 and the third region R3, and larger than the sucking force in the first region R1 in the case, shown in FIG. 4B, where the ink In is applied to the downstream part of a recording medium P. If images are recorded on recording media P on the basis of different image data, the sucking force in the first region R1 may be controlled and adjusted for each recording medium P.

### [Second Modification]

Next, a second modification of the above embodiment will be described. This modification may be combined with the first modification.

This modification differs from the above embodiment in that a gas sucker 344 (gas circulator) is used instead of the second air knife 342. Hereinafter, points in which the second modification differs from the above embodiment are described.

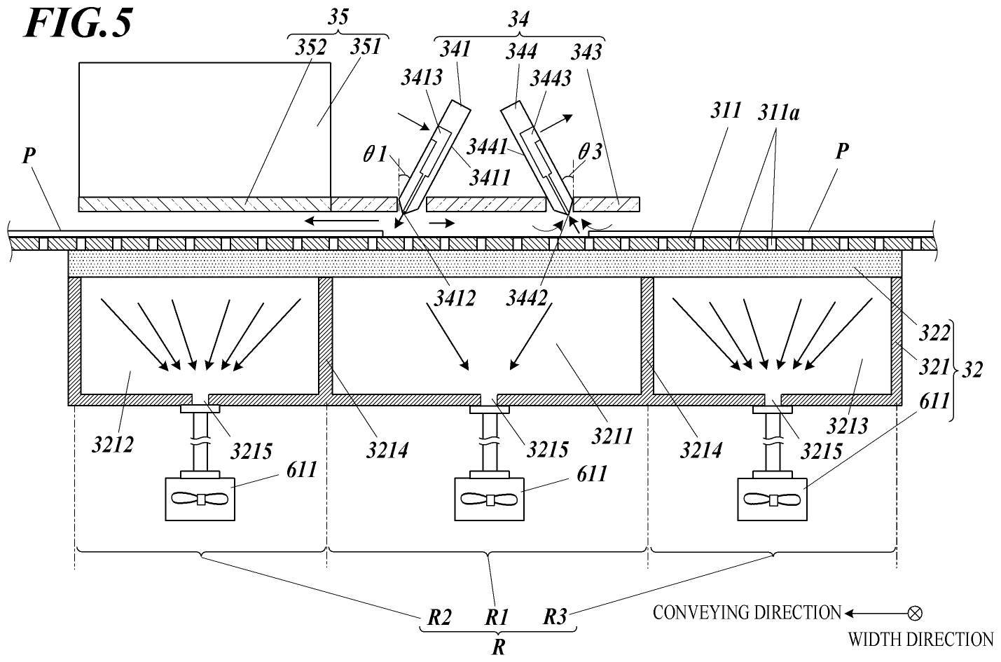

FIG. 5 is a schematic cross-sectional view showing part of the fixing unit 30 according to this modification in an enlarged manner.

The fixing unit 30 in this modification includes the gas sucker 344 that sucks gas over the placement surface of the conveying belt 311. The gas sucker 344 is provided at one of the two opening parts of the partition plate 343, the one being upstream in the conveying direction. The gas sucker 344 has a flat-plate-shaped main body 3441 that is, in the width direction, longer than the width of recording media P. At the tip of the main body 3441, a gas suction port 3442 having a slit is provided. Inside the main body 3441, a gas flow channel 3443 that communicates with the gas suction port 3442 is provided. By air in the gas flow channel 3443 being sucked from outside, the gas sucker 344 sucks the air over the placement surface through the gas sucking port 3442, which communicates with the gas flow channel 3443.

The gas sucker 344 is arranged such that the extending direction of the main body 3441 slants downstream in the conveying direction from the vertical direction by an angle θ3. The gas sucker 344 sucks the air in a direction along the extending direction of the main body 3441. That is, the gas sucker 344 sucks the air over the placement surface in a direction having a component following the conveying direction. In this embodiment, an absolute value of the angle θ3 is the same as the absolute value of the angle θ1, but may be different from that of the angle θ1.

The gas sucker 344 sucks the air over the placement surface of the conveying belt 311, thereby flowing and stirring the layer of the gas over the placement surface. This can smoothly spread nitrogen supplied by the first air knife 341 in the first partition space, and efficiently decrease the oxygen concentration in the second partition space.

### [Third Modification]

Next, a third modification of the above embodiment will be described. This modification may be combined with the other modifications.

This modification differs from the above embodiment in that the support-suction unit 32 does not perform suction in the first region R1. Hereinafter, points in which the third modification differs from the above embodiment are described.

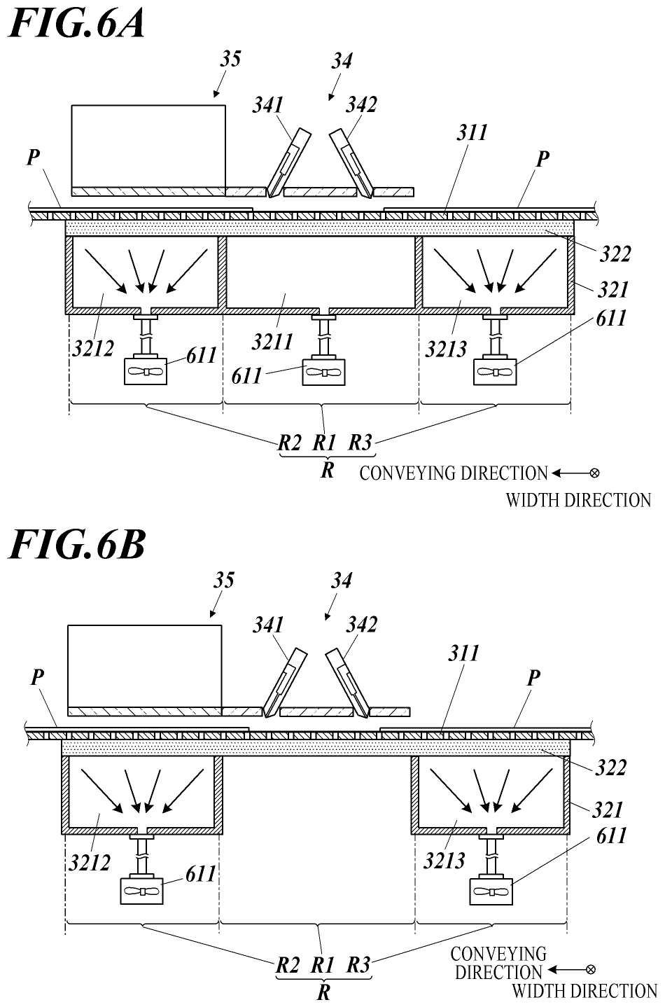

As shown in FIG. 6A, in the support-suction unit 32 in this modification, the suction fan 611 that communicates with the air chamber 3211, which is located at the middle in the conveying direction, does not rotate and hence does not perform suction in the first region R1. Because nitrogen supplied from the first air knife 341 and the second air knife 342 is not sucked to the air chamber 3211, the nitrogen can more efficiently fill the first partition space, and decrease the oxygen concentration in the second partition space.

Alternatively, as shown in FIG. 6B, no air chamber may be provided in the first region R1, and the suction fans 611 may perform suction through the air chamber 3212 in the second region R2 and the air chamber 3213 in the third region R3 only.

In this modification, because recording media P are not attracted in the first region R1, a guide member that presses recording media P from above in the first region R1, such as a pressing roller, may be provided for using such as thin recording media P, which are easy to float while being conveyed.

As described above, the curing apparatus according to the embodiment including the fixing unit 30, the controller 50 and the suction controller 61 is a curing apparatus that applies ultraviolet rays to ink that cures by application of ultraviolet rays, including: the conveying belt 311 that has a placement surface on which a recording medium/media P is placed; the conveyance motor 631 that causes the conveying belt 311 to circle along a predetermined circular path; the support-suction unit 32 that performs, on a side of the conveying belt 311 opposite to a placement-surface side where the placement surface is provided, a suction operation of sucking gas over the placement surface through the hole parts 311a of the conveying belt 311, thereby attracting the recording medium P placed on the placement surface to the placement surface in the suction-attracting region R of the circular path; the first air knife 341 that supplies nitrogen as a low-oxygen gas having an oxygen concentration lower than the oxygen concentration of air to the placement surface in the first region R1 being part of the suction-attracting region R; and the ultraviolet irradiator 35 that irradiates the ink on the recording medium P attracted to the placement surface with ultraviolet rays in the second region R2 that is in the suction-attracting region R and downstream from the first region R1 in the conveying direction, wherein the support-suction unit 32 performs the suction operation such that the sucking force in the first region R1 is smaller than the sucking force outside the first region R1.

Thus, the support-suction unit 32 performs the suction operation such that the sucking force in the first region R1 is smaller than the sucking force outside the first region R1, which can reduce the suction amount of nitrogen sucked by the support-suction unit 32, the nitrogen being supplied from the first air knife 341 to the placement surface of the conveying belt 311 in the first region R1. This can more efficiently fill the first region R1, namely over the placement surface in the first region R1, with the supplied nitrogen. Furthermore, the nitrogen moving to the second region R2 as the conveying belt 311 and the recording medium P moving in the conveying direction (especially, the nitrogen over/on the recording medium P moving as the recording medium P moving) can efficiently decrease the oxygen concentration over/on the placement surface in the second region R2. This can more certainly keep oxygen from inhibiting polymerization in the ink, and more efficiently cure the ink.

Furthermore, the curing apparatus according to the embodiment includes the air chambers 3211, 3212, 3213 that are provided on the side of the conveying belt 311 opposite to the placement-surface side in an area corresponding to the suction-attracting region R, and from each of which gas is sent to the placement-surface side of the conveying belt 311 and vice versa through a channel passing through at least one of the hole parts 3111a of the conveying belt 311, wherein the air chambers include the air chamber 3212 provided in an area corresponding to the first region R1 and the air chambers 3211, 3213 provided in an area(s) corresponding to the outside of the first region R1, and in the suction operation, the support-suction unit 32 sucks the gas from the inner-circumferential-surface side of the conveying belt 311 through the air chambers 3211, 3212, 3213 such that the sucking force in the air chamber 3212 is smaller than the sucking force in each of the air chambers 3211, 3213. This simple configuration can easily make the sucking force for attracting the recording medium P in the first region R1 smaller than the sucking force outside the first region R1.

Furthermore, the support-suction unit 32 according to the third modification sucks, in the suction operation, the gas over the placement surface through, among the air chambers 3211, 3212, 3213, the air chambers 3211, 3213 provided outside the first region R1 only. This can make, in the first region R1, the sucking force of the support-suction unit 32 for sucking nitrogen supplied from the first air knife 341 extremely small, and consequently more efficiently fill over the placement surface with the nitrogen and decrease the oxygen concentration in the second region R2. Furthermore, because an air chamber(s) that sucks the gas can be selected from among the air chamber 3212 in the first region R1 and the other air chambers 3211, 3213, suction in the first region R1 can be made available or unavailable.

Furthermore, the support-suction unit 32 according to the third modification includes the air chambers 3212, 3213 that are provided on the side of the conveying belt 311 opposite to the placement-surface side in an area(s) corresponding to the outside of the first region R1 in the suction-attracting region R, and from each of which gas is sent to the placement-surface side of the conveying belt 311 and vice versa through a channel passing through at least one of the hole parts 311a of the conveying belt 311, wherein in the suction operation, the support-suction unit 32 sucks the gas from the inner-circumferential-surface side of the conveying belt 311 through the air chambers 3212, 3213. This can keep nitrogen supplied from the first air knife 341 from being sucked by the support-suction unit 32 in the first region R1, and consequently more efficiently fill over the placement surface with the nitrogen and decrease the oxygen concentration in the second region R2.

Furthermore, the curing apparatus according to the embodiment includes the second air knife 342 that flows the gas over the placement surface by supplying, in the first region R1, nitrogen to the placement surface in an area upstream in the conveying direction from an area to which the first air knife 341 supplies nitrogen. According to this configuration, nitrogen supplied from the second air knife 342 to the placement surface can flow and stir the layer of the gas over the placement surface. This can smoothly spread nitrogen supplied from the first air knife 341 over the placement surface, and more efficiently decrease the oxygen concentration in the second region R2. Furthermore, because the support-suction unit 32 performs the suction operation such that the sucking force in the first region R1 is smaller than the sucking force outside the first region R1, the suction amount of nitrogen sucked by the support-suction unit 32 can be made small, the nitrogen being supplied from the second air knife 342 in the first region R1. This can efficiently flow and stir the layer of the gas over the placement surface.

Furthermore, the second air knife 342 ejects the nitrogen to the placement surface in a direction having a component counter to the conveying direction. This supplies nitrogen from the second air knife 342 in the direction having the component opposite to the laminar flow of the gas over the placement surface, and consequently can effectively stir the layer of the gas over the placement surface.

Furthermore, the fixing unit 30 according to the second modification includes the gas sucker 344 that flows the gas over the placement surface by sucking, in the first region R1, the gas over the placement surface in an area upstream in the conveying direction from an area to which the first air knife 341 supplies nitrogen. Thus, the gas sucker 344 sucks the gas over the placement surface, which can flow and stir the layer of the gas over the placement surface. This can smoothly spread nitrogen supplied from the first air knife 341 over the placement surface, and more efficiently decrease the oxygen concentration in the second region R2. Furthermore, because the support-suction unit 32 performs the suction operation such that the sucking force in the first region R1 is smaller than the sucking force outside the first region R1, the gas sucker 344 can efficiently suck the gas in the first region R1, which can effectively flow and stir the layer of the gas over the placement surface.

Furthermore, the first air knife 341 ejects the gas to the placement surface in a direction having a component following the conveying direction. This supplies nitrogen from the first air knife 341 in the direction having the component following the laminar flow of the gas over the placement surface, and consequently can more efficiently fill over the placement surface with the nitrogen.

Furthermore, the curing apparatus according to the embodiment includes the partition plates 343, 352 that limit, in the first region R1 and the second region R2, a flow area(s) of the gas over the placement surface in a direction perpendicular to the placement surface. This can limit diffusion of nitrogen supplied from the first air knife 341, and more efficiently increase the nitrogen concentration and decrease the oxygen concentration accordingly over the placement surface in the first region R1 and the second region R2.

Furthermore, the curing apparatus according to the first modification includes the controller 50 and the suction controller 61 as the suction controlling unit that causes the support-suction unit 32 to perform the suction operation such that the sucking force in the first region R1 is smaller in response to the ink being applied to the downstream part of the recording medium P in the conveying direction than in response to the ink being not applied to the downstream part of the recording medium P. This can certainly decrease the oxygen concentration in curing the ink applied to the downstream part of the recording medium P. Furthermore, making the sucking force in the first region R1 relatively larger in response to the ink being not applied to the downstream part of the recording medium P can more certainly attract the recording medium P to the conveying surface.

Furthermore, the curing apparatus according to the embodiment includes the recording medium feeder 10 that places recording media P on the placement surface of the conveying belt 311, which circles along the circular path, at intervals of a distance that is shorter than the length of the first region R1 in the conveying direction. Hence, at any timing of the circular movement of the conveying belt 311, the recording medium/media P is placed on the placement surface of the conveying belt 311 in at least one of the regions adjacent to the first region R1 along the conveying direction. This can hinder the support-suction unit 32 from sucking nitrogen supplied from the first air knife 341.

Furthermore, the inkjet recording apparatus 1 according to the embodiment includes: the head units 24 that jet, from the nozzles to a recording medium/media P, ink made up of a curable material that cures by application of ultraviolet rays; and the curing apparatus described above. Hence, the ink jet recording apparatus 1 can efficiently cure and fix the ink on the recording medium P.

The present invention is not limited to the above embodiment or modifications, and can be variously modified.

For example, although the conveying belt 311 is cited as an example of the placement member that circles along a predetermined circular path in the above embodiment and modifications, the placement member is not limited to this.

The placement member may be, for example, a cylindrical drum that rotates on a predetermined shaft. In this case, recording media P can be attracted to the surface of the rotatable drum by providing the drum with hole parts for gas permeability, and sucking air from a support-suction unit fixed to the shaft in the drum.

The placement member may be configured to go and return in its movable area that includes the suction-attracting region R.

Furthermore, although the ultraviolet curable ink is cited as an example of the curable material in the above embodiment and modifications, this does not mean a limitation. As the curable material, various materials that cure as monomers become macromolecules by polymerization that progresses by application of predetermined energy can be used. Examples thereof include: a thermosetting material in which polymerization progresses by application of heat; and an electron-beam curable material in which polymerization progresses by irradiation of electron beams.

Furthermore, although the individual suction fans 611 suck the air in the corresponding air chambers of the support-suction unit 32 as an example in the above embodiment and modifications, a single suction fan 611 may suck the air in the air chambers instead. For example, under the air chambers shown in FIG. 3, a common air chamber that communicates with the air chambers through vent holes may be provided, and the air in the common air chamber may be sucked by the single suction fan. In this case, the sucking force in each air chamber can be adjusted by changing the total opening area of the vent holes provided for each air chamber.

The support-suction unit 32 may have no air chamber. For example, the support-suction unit 32 may be configured to make the sucking force in the first region R1 relatively small by arranging, in a lower layer of the porous member 322, a filter having a mesh size that is smaller in the first region R1 than in the second region R2 and the third region R3, and performing suction with the suction fans 611 through the filter.

Furthermore, although nitrogen is cited as an example of the gas that is supplied from the first air knife 341 and the second air knife 342 to the placement surface of the conveying belt 311 in the above embodiment and modifications, the gas is not limited to this. An inert gas, such as a rare gas, or any other gas having an oxygen concentration lower than the oxygen concentration of air may be used.

Furthermore, although the nitrogen-supplying directions of the first air knife 341 and the second air knife 342 and the air-sucking direction of the gas sucker 344 slant from the vertical direction as an example in the above embodiment and modifications, all or some of these directions may be vertical.

Furthermore, the first air knife 341 and the second air knife 342 each are not limited to ejecting nitrogen from the slit that extends in the width direction, and may have, for example, a plurality of nitrogen-ejecting nozzles arranged in the width direction.

Furthermore, the area to which the first air knife 341 and the second air knife 342 each supply nitrogen is not limited to the linear area that extends in the width direction, and may also extend for a certain length in the conveying direction.

Although some embodiments or the like of the present invention have been described, the scope of the present invention is not limited to the embodiments or the like but includes the scope of the present invention described in the scope of claims and the scope of their equivalents.

### INDUSTRIAL APPLICABILITY

The present invention is applicable to a curing apparatus and an ink jet recording apparatus.

### REFERENCE SIGNS LIST

1 ink jet recording apparatus
10 recording medium feeder
20 image recorder
21 conveyance unit
22 support-suction unit
23 pressing roller
24 head unit
241 recording head
30 fixing unit
31 conveyance unit
311 conveying belt
311a hole part
312, 313 conveying roller
32 support-suction unit
321 casing
3211, 3212, 3213 air chamber
3214 partition wall
3215 suction port
322 porous member
33 pressing roller
34 oxygen concentration decrease unit
341 first air knife
342 second air knife
343 partition plate
344 gas sucker
35 ultraviolet irradiator
351 mainbody
352 partition plate
40 recording medium receiver
50 controller
61 suction controller
611 suction fan
62 head controller
63 conveyance controller
631 conveyance motor
In ink
P recording medium
R suction-attracting region
R1 first region
R2 second region
R3 third region

1. A curing apparatus that applies predetermined energy to a curable material that cures by application of the predetermined energy, comprising:
a placement member that has a placement surface on which a placement target is placed;
a conveyance driver that moves the placement member along a predetermined movement path;
a sucker that performs, on a side of the placement member opposite to a placement-surface side where the placement surface is provided, a suction operation of sucking gas over the placement surface through a plurality of hole parts of the placement member, thereby attracting the placement target placed on the placement surface to the placement surface in a predetermined suction-attracting region of the movement path;
a gas supplier that supplies a low-oxygen gas having an oxygen concentration lower than an oxygen concentration of air to the placement surface in a predetermined first region being part of the suction-attracting region; and
an energy applier that applies the predetermined energy to the curable material on the placement target attracted to the placement surface, in a predetermined second region that is in the suction-attracting region and downstream from the first region in a moving direction of the placement surface in the suction-attracting region, the placement surface moving according to the movement of the placement member, wherein
the sucker performs the suction operation such that a sucking force in the first region is smaller than a sucking force outside the first region.

2. The curing apparatus according to claim 1, comprising a plurality of air chambers that are provided on the side of the placement member opposite to the placement-surface side in an area corresponding to the suction-attracting region, and from each of which gas is sent to the placement-surface side of the placement member and vice versa through at least one of the hole parts of the placement member, wherein
the air chambers include a first air chamber provided in an area corresponding to the first region and one or more second air chambers provided in an area corresponding to the outside of the first region, and
in the suction operation, the sucker sucks the gas from the side of the placement member opposite to the placement-surface side through the air chambers such that the sucking force in the first air chamber is smaller than the sucking force in the one or more second air chambers.

3. The curing apparatus according to claim 2, wherein in the suction operation, the sucker sucks the gas through, among the air chambers, the one or more second air chambers only.

4. The curing apparatus according to claim 1, comprising an air chamber that is provided on the side of the placement member opposite to the placement-surface side in an area corresponding to the outside of the first region in the suction-attracting region, and from which gas is sent to the placement-surface side of the placement member and vice versa through at least one of the hole parts of the placement member, wherein
in the suction operation, the sucker sucks the gas from the side of the placement member opposite to the placement-surface side through the air chamber.

5. The curing apparatus according to claim 1, comprising a gas circulator that flows the gas over the placement surface by supplying, in the first region, a predetermined gas to the placement surface in an area upstream in the moving direction from an area to which the gas supplier supplies the low-oxygen gas.

6. The curing apparatus according to claim 5, wherein the gas circulator sends the predetermined gas to the placement surface in a direction having a component counter to the moving direction.

7. The curing apparatus according to claim 1, comprising a gas circulator that flows the gas over the placement surface by sucking, in the first region, the gas over the placement surface in an area upstream in the moving direction from an area to which the gas supplier supplies the low-oxygen gas.

8. The curing apparatus according to claim 1, wherein the gas supplier sends the low-oxygen gas to the placement surface in a direction having a component following the moving direction.

9. The curing apparatus according to claim 1, comprising a flow area limiting member that limits, in the first region and the second region, a flow area of the gas over the placement surface in a direction perpendicular to the placement surface.

10. The curing apparatus according to claim 1, comprising a hardware processor that causes the sucker to perform the suction operation such that the sucking force in the first region is smaller in response to the curable material being applied to a predetermined area of the placement target including a top of the placement target in the moving direction than in response to the curable material being not applied to the predetermined area of the placement target.

11. The curing apparatus according to claim 1, wherein
the conveyance driver causes the placement member to circle along a predetermined circular path as the predetermined movement path.

12. An ink jet recording apparatus comprising:
a jetter that jets, from a nozzle to a placement target, ink made up of a curable material that cures by application of predetermined energy; and
the curing apparatus according to claim 1.

13. The ink jet recording apparatus according to claim 12, comprising a placement target feeder that places placement targets each of which is the placement target on the placement surface of the placement member, which is moved along the predetermined movement path, at intervals of a distance that is shorter than a length of the first region in the moving direction.
